(19) United States
(12) Patent Application Publication
(10) Pub. No.: US 2011/0308628 A1
(43) Pub. Date: Dec. 22, 2011

(54) WATER HEATER DRAIN HOSE AND METHOD OF USE

(76) Inventor: Harold Richard Nugent, Fuquay-Varina, NC (US)

(21) Appl. No.: 13/165,142

(22) Filed: Jun. 21, 2011

Related U.S. Application Data
(60) Provisional application No. 61/398,113, filed on Jun. 21, 2010.

(51) Int. Cl. F17D 1/16; F16L 55/10

(52) U.S. Cl. 137/13; 138/89; 137/237

(57) ABSTRACT

A drain hose and method for improving the flow of water from a water heater during draining by cleaning the drain valve of the water heater and the water hose. The apparatus and method provide improved drainage, where the improvement is provided by inclusion of an agitator for agitating the drainage water, wherein such agitation disturbs and removes debris within the drain valve of the water heater and within the drain hose itself.

### CROSS REFERENCE TO RELATED APPLICATIONS

This application claims the benefit of U.S. Provisional Application No. 61/398,113, filed Jun. 21, 2010. The disclosure of such provisional application is incorporated by reference herein in its entirety, for all purposes.

### FIELD OF THE INVENTION

The present invention relates to the drainage of a water heater. The disclosure contemplates an improved drain hose and method of use, wherein the drain hose and method of use provide reduction of debris deposited in the water heater drain valve and drain hose by agitation of the water in the drain hose, thereby improving the flow of water from the water heater during drainage.

### DESCRIPTION OF THE RELATED ART

In operation of conventional water heaters, both residential and commercial, there is a periodic need to drain the water heaters. Such drainage may be for the purpose of a temporary shut down of the water heater, such as for vacation or a seasonal closure of a residence or may be for the purpose of cleaning the water heater. Drainage may also be for the purpose of performing maintenance on the water heater, such as replacing heating elements or repairing a leaking water tank. To facilitate such drainage, water heaters are typically provided with a drain valve at the bottom of the heater tank.

The water source for a water heater is generally the same as the water source for the tap water in a home or business. The water may be a municipal source or well water, however, regardless of the source, the water will generally contain impurities, which may settle out of the water into the tank, in the form of sediment or other debris.

The presence of such debris in the water heater can impede the normal operation of the water heater. The debris may settle on the walls of the water heater or at the bottom of the water heater. Accumulation of debris within the water heater can displace water and reduce the amount of heated water available to a user. Additionally, the debris can weaken the components of the water heater and can result in slower heating and/or overheating. The debris present within the water heating system can further obstruct the pumps, valves or other operating elements within the water heater. Such debris may cause blockage, in whole or in part, of drainage of water from the tank of the water heater.

Various approaches to eliminating the debris within the water heater have been attempted. Such approaches include filtration of the water source supplying the water heater, adding chemical solutions to the tank in order to dissolve the buildup, physically scraping the interior of the tank or spraying the interior with water jets. However, these methods are disadvantageous in that they can be time consuming, release chemicals into the water supply, require repetition to fully clean the tank, and/or waste water, as the tank is filled and flushed multiple times in order to rinse all of the debris away.

In consequence, the art continues to seek improvements in removal of debris from the drain valve of a water heater, where the debris slows or stops the flow of water in drainage of the tank. This invention provides a method and apparatus for removal of such debris from a water heater drain valve during the water heater drainage process.

### SUMMARY OF THE INVENTION

The present invention relates to an apparatus and method for improved draining of a water heater.

In one aspect the invention relates to a drain hose for drainage of a water heater, the hose comprising a drainage tube for drainage of water from the water heater, an agitator for agitating water within the drain hose, wherein the agitator is secured to the drainage tube, an exit valve for stopping the flow of water through the drainage tube, wherein the exit valve is located downstream of the agitator, a first connection at a proximal end of the drain hose for connecting the drain hose to a drain valve of the water heater, and a second connection at a distal end of the drain hose for connecting the drain hose to suitable drainage location. Activation of the agitator of the drain hose provides agitation sufficient to increase the pressure of the water in the drain hose, and the increased pressure provides a flow of water from the drain hose sufficient to reduce debris in the drain valve or the drain hose.

In another aspect, the invention relates to a method for improving the flow of water from a water heater during draining, the method comprising the steps of connecting a drain hose at one end to a water heater drain valve, turning off the water heater heating element, turning off the supply of water to the water heater, providing air intake to the water heater, opening the drain valve on the water heater, closing the exit valve on the drain hose, activating the agitator on the drain hose to increase pressure of water in the drain hose, produce a reverse flow of water into the drain valve, and wherein the increased pressure provides a flow of water from the drain hose sufficient to reduce debris in the drain valve or the drain hose, opening the exit valve on the drain hose to flush a mixture of debris and water from the hose, and repeating the steps of closing the exit valve, activating the agitator and opening the valve, until a desired flow of water from the water heater during draining is achieved.

In a further aspect, the invention provides a system for improved drainage of a water heater, comprising a drain hose connected to a water heater.

Other aspects, features and embodiments of the invention will be more fully apparent from the ensuing disclosure and appended claims.

### BRIEF DESCRIPTION OF THE DRAWINGS

FIG. 1 is an exemplary drain hose of the invention.

### DETAILED DESCRIPTION OF THE INVENTION, AND PREFERRED EMBODIMENTS THEREOF

The present invention relates to improved drainage of a water heater and an apparatus for improved drainage of a water heater by removal of debris in the water heater drain valve during the drainage of the water heater. The disclosure contemplates an improved drain hose and method of use.

The presence of debris in a water heater can impede or obstruct the flow of water from the drain valve of the water heater during drainage of a water heater. The apparatus and method of the invention provide for disturbance, reduction, removal, flushing, and/or clearance of debris present in a water heater drain valve, during drainage of the water heater, resulting in an improved flow of water from the drain valve. Debris removed by the apparatus and method of the invention may include, but is not limited to, sediment, sand, dirt, rust, scale, mineral deposits or other impurities.

The invention provides a drain hose useful in an improved method of draining a water heater, where the drain hose is useful in cleaning the drain valve of a water heater to which it is connected during the drainage of the water heater. The drain hose is particularly advantageous in that it uses the water being drained from the water heater to clean debris in the drain valve. The drain hose promotes faster draining of the water from the water heater due to its ability to clean the water heater drain valve by engagement of an agitation function of the drain hose, prior to and during drainage of water from the water heater, as necessary. Such agitation function also serves to clean the drain hose itself, as the water heater is being drained.

The invention therefore provides a drain hose and method for drainage of a water heater and cleaning of the drain valve of the water heater and water hose by agitation of the drainage water during drainage of the water heater. The drain hose and method provide improved speed of the drainage process, as compared to traditional drainage methods not incorporating a cleaning method. The agitation of the drainage water, as provided by the drain hose and method of the invention, disturbs and removes debris within the drain valve of the water heater and/or within the drain hose itself. Such debris is flushed from the system with the drainage water. The degree of agitation and the time of agitation can be adjusted according to the amount of debris and the extent of the blockage. The agitation can be repeated during the drainage of the water heater in order to remove additional debris and to achieve the desired drainage water flow.

In one embodiment, the drain hose comprises a drainage tube for drainage of water from the water heater, an agitator secured to the drainage tube, and an exit valve located downstream of the agitator. In a preferred embodiment, the agitator is secured between two lengths of drainage tube.

A drainage tube of the drain hose of the invention can be of any type of material suitable for drainage of water from a water heater, in consideration of the fact that the water being drained from the tank of the water heater may be at temperatures in excess of 180° F. The drainage tube therefore must comprise a material capable of maintaining structural and functional integrity at high temperatures. The drainage tube may, in alternate embodiments, be rigid or flexible, clear or obscure. The tube may further comprise scaffolding or braiding within the tube walls, as necessary to contain water at high temperature. Alternatively, the drainage tube may be piping or tubing, such as, but not limited to metal or PVC piping.

The drainage tube may be of any size or length effective to drain a water heater. The drain hose will extend from the drain valve of the water heater to a suitable drainage location, wherein much of the total length of the drain hose comprises the drainage tube.

The drain hose further comprises an agitator, which is secured to the drainage tube. In one embodiment the agitator is secured to an end of the drainage tube. In a particularly preferred embodiment the agitator has two open ends and is secured between two lengths of drainage tube.

In one embodiment the agitator is any device that serves to agitate the water in the drain hose and is sufficient to increase the pressure of the water in the drain hose when the exit valve of the drain hose is closed and the agitator is activated. By the increased pressure generated by activation of the agitator, the flow of the water out of the water heater is temporarily reversed and the water in the drain hose is directed toward and into the water heater, rather than draining out of the water heater toward a suitable drainage location. Such reverse flow is sufficient to disturb debris within the water heater drain valve and/or within the drain hose itself. Once the debris is so disturbed, it will be flushed out with the drainage water when the exit valve is opened and normal drainage flow is resumed. As the debris is flushed out, any blockage caused by the debris is reduced or eliminated and the drainage flow is increased.

In a further embodiment, the agitator may be activated during the flow of water through the drain hose, without closing the exit valve, and such activation is sufficient to increase the pressure of the water in the drain hose. Activation of the agitator without closing the exit valve may produce a lesser disturbance of debris as compared to activation when the exit valve is closed and is therefore useful when the blockage is minimal or after an initial blockage has been treated with agitation with the exit valve closed.

In various embodiments the agitator is a squeeze ball or bulb, or any other device effective to agitate the water in the drain hose, as described herein. The agitator comprises any type of material suitable for drainage of water from a water heater, particularly water at elevated temperatures.

Activation of the agitator may comprise squeezing the ball or bulb, stepping on such ball or bulb, compressing the ball or bulb, or any other manner of agitating the water in the drain hose.

In order to connect the drain hose of the invention to a water heater and effect drainage from and cleaning of the water heater drain valve, the drain hose has a connector at either end. At one end, the connector is sufficient to attach the drain hose to the drain valve of a water heater. At the other end the connector is sufficient to attach the drain hose to any suitable drainage location. In operation, the connection to a suitable drainage location is optional. A suitable drainage location is any locale at which the water drained from the water heater may be disposed. Such locales may include, but are not limited to, a garden hose, a tub, or a drain.

Connections described herein may be made by any manner of securing or fastening known to those of skill in the art. Such securing or fastening may include, but is not limited to, hose clamps, or similar devices, such as brass, aluminum, copper, steel, clamps, sleeves or rings.

Connections of the drain hose to the water heater drain valve and/or the suitable drainage location are made in a manner sufficient to permit flow of water from the water heater through the drain hose to the suitable drainage location, without leakage. Prevention of leakage is important, particularly when the temperature of the water is high, but also in order to minimize clean up following drainage of the water heater.

The drain hose of the invention further includes an exit valve. Such exit valve may be any device known to stop the flow of water from exiting the drain hose. In one embodiment the exit valve is a ball valve. Such exit valve may be opened or closed, in order to control the water flow. When the exit valve is opened, the water will flow from the water heater, through the drain hose to the suitable drainage location. When the exit valve is closed, water will flow from the water heater, into the drain hose, but the further flow of the drainage water out of the drain hose to the suitable drainage location is prevented.

In operation of the invention, the exit valve may be closed and the agitator activated, to increase the pressure of the water in the drain hose. By such increased pressure, the flow of the water out of the water heater is temporarily reversed and the water in the drain hose is directed back up the drain hose and into the drain valve of the water heater, effective to disturb debris in the water heater drain valve and/or the drain hose. When the valve is opened again, a mixture of the debris and water may be flushed out of the drain hose and therefore removed from the drain valve and/or drain hose. In a further embodiment the agitator may be activated with the exit valve open.

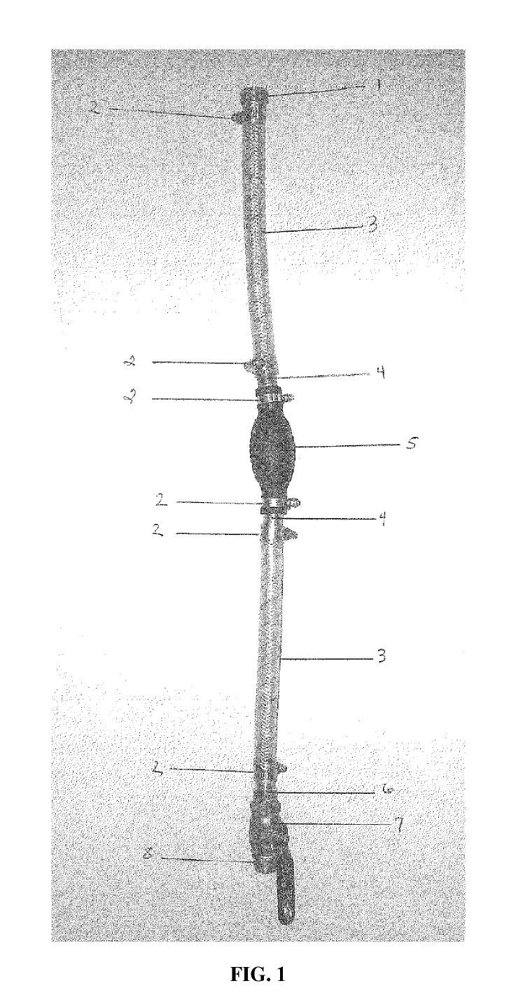

FIG. 1 provides an exemplary drain hose of the invention. A first connection 1 is provided as the connection at the proximal end of the drain hose 3 for connection to a water heater. Fasteners 2 are provided to secure the individual elements of the drain hose. An agitator 5 in the form of a squeeze ball is located in the middle of the drainage tube 3 and is secured to the drainage tube at ends 4 and 6 via fasteners 2. An exit valve 7, when engaged, stops the flow of water from exiting the drain hose. At the distal end of the drain hose is provided a second connection 8 for connection of the drain hose to a suitable drainage location.

In another embodiment the invention provides a system for drainage of a water heater, comprising a drain hose, as described herein, connected to a water heater. The system is effective to drain the water heater and to improve the flow of the water from the water heater during the drainage process.

The invention further provides a method of improving the flow of water from a water heater during draining of the water heater. The methods of the invention are useful to improve the drainage of a water heater with debris providing a partial or complete blockage of the drain valve of the water heater. Such method includes use of a drain hose, as described herein.

In preparation for draining a water heater, the flow of water from the drain valve should be initially evaluated. Such evaluation may be made before or after connection of a drain hose. As a result of the evaluation, it is determined whether the flow needs to be improved. Limitation of such flow or a lack of such flow may be attributed to a partial or complete blockage of the drain valve by debris in the drain valve. Use of the drain hose and methods of the invention will clear such blockage in whole or in part and improve flow of the drainage water from the water heater.

In further preparation for drainage of a water heater, the water supply to the water heater should be turned off, disconnected or otherwise stopped. Additionally, the heating element should be turned off, such that the water is not being heated. This may include any known manner of turning the heating element off, such as, but not limited to, turning the fuel source (gas or electric) off. As such, once the heater is drained, the heating element is not damaged. Any circulation pump or other circulating components within the water heater should also be turned off prior to drainage of the water heater. As the water is drained from the water heater, since it is not being replaced by additional water, it is necessary to provide an air intake to the water heater during drainage. In one embodiment the air intake is provided by opening a faucet on the hot water side of the water heater, once the water supply has been turned off. Once a water heater is prepared for drainage by turning off the water heating element, turning off the water supply and providing an air intake, the water heater is ready for drainage.

In an embodiment of the invention, a drain hose, as described herein, is connected to a drain valve of a water heater to be drained. The drain valve on the water heater is opened, to allow drainage of water from the water heater into the drain hose and through the drain hose to a suitable drainage location. When cleaning of the drain valve and/or drain hose is desired, the exit valve of the drain hose is closed and the flow of water out of the drain hose is temporarily halted. The agitator on the drain hose is activated, sufficient to increase the pressure of the water in the drain hose and temporarily reverse the flow of water to direct the water in the drain hose toward and into the water heater, rather than draining out of the water heater toward a suitable drainage location. The increased pressure and reverse flow is further sufficient to disturb and remove debris in or on the drain valve and/or drain hose. Activation of the agitator may be repeated with the exit valve open or closed, in order to further disturb debris in or on the drain valve and/or drain hose.

In a further embodiment the agitator is activated when the exit valve is open. Such agitation is sufficient to increase the pressure of the water in the drain hose and disturb debris in the water valve and the drain hose. The disturbance of the debris by such activation may be less than when the exit valve is closed. Activation of the agitator with the exit valve open is useful when the blockage is minimal or after an initial blockage has been treated. Activation of the agitator with the exit valve open may be performed in lieu of or in addition to activation with the exit valve closed. Generally, an extreme blockage will require treatment with the exit valve closed to provide an initial removal of debris. Activation of the agitator with the exit valve open may provide further debris removal while the water is draining through the drain hose to the suitable drainage location.

In one embodiment the activation of the agitator is squeezing or other compression of a squeeze ball or bulb sufficient to increase the pressure within the drain hose and temporarily reverse the flow of the water in the drain hose while the bulb is so activated. When the agitator is activated, water will be directed toward and into the water heater, sufficient to disturb debris within the water heater drain valve and/or within the drain hose itself. The disturbance of debris will generally be greater when the exit valve is closed prior to activation of the agitator.

Upon opening of the drain hose exit valve, a mixture of debris and water is flushed from the water heater and drain hose. As the debris is flushed out, any blockage caused by the debris is reduced or eliminated and the drainage flow is increased. The flow of water from the drain hose is evaluated. If desired, the steps of closing the exit valve, activating the agitator and opening the exit valve may be repeated, as necessary, to remove further debris and to achieve a desired improved flow of water from the water heater during draining. Alternatively or additionally, the step of activating the agitator may be repeated, as necessary, to achieve a desired improved flow of water from the water heater during draining, without closing the exit valve prior to such activation.

In an alternative embodiment, particularly in a situation where the flow is extremely limited or completely blocked upon initiation of the drainage of the water heater, the exit valve of the drain hose is closed and the drain hose filled with water, prior to connection to the water heater. The agitator is activated to reduce the debris causing such limited flow or blockage and to improve flow.

The advantages and features of the invention are further illustrated with reference to the following example, which is not to be construed as in any way limiting the scope of the invention but rather as illustrative of one embodiment of the invention in a specific application thereof.

### Example 1

A drain hose of the type shown schematically in FIG. 1 may be employed in the drainage of a water heater and cleaning of the drain valve and/or the drain hose during such drainage. An exemplary drain hose has been developed with the following specifications, indicated with respect to the reference numerals of FIG. 1.

A ¾ inch brass male hose insert and female hose thread adapter with hose washer 1 are provided as the first connection at the proximal end of the drain hose. A ¾ inch stainless steel hose clamp 2 is provided to attach the first connection to the drainage tube. A high temperature clear braided hose (12 inch length) 3 is provided as the drainage tube. A rubber squeeze ball 5 provides an agitator, which is located in the middle of the drainage tube 3. The rubber squeeze ball 5 is secured to the drainage tube at ends 4 and 6, where 4 is a ¾ inch brass st. and insert hose adapter and 6 is a ¾ inch male ips. and hose thread insert adapter. A ¾ inch fip. brass ball valve with lever handle 7 is provided as the exit valve, which, when engaged, stops the flow of water from exiting the drain hose. At the distal end of the drain hose is provided a second connection, a ¾ inch male ips. and male hose thread connector 8 for connection of the drain hose to a suitable drainage location.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A drain hose for drainage of a water heater, the drain hose comprising:
a drainage tube for drainage of water from the water heater;
an agitator for agitating water within the drain hose, wherein the agitator is secured to the drainage tube;
an exit valve for stopping the flow of water through the drainage tube, wherein the exit valve is located downstream of the agitator;
a first connection at a proximal end of the drain hose for connecting the drain hose to a drain valve of the water heater; and
a second connection at a distal end of the drain hose for connecting the drain hose to suitable drainage location;
wherein activation of the agitator provides agitation sufficient to increase the pressure of the water in the drain hose, and wherein the increased pressure provides a flow of water from the drain hose sufficient to reduce debris in the drain valve or the drain hose.

2. The drain hose of claim 1, wherein the drainage tube is selected from the group consisting of piping or tubing.

3. The drain hose of claim 1, wherein the agitator comprises a squeeze ball.

4. The drain hose of claim 1, further comprising a second drainage tube, wherein the agitator is secured between the two drainage tubes.

5. The drain hose of claim 1, wherein the exit valve comprises a ball valve.

6. A method for improving the flow of water from a water heater during draining, the method comprising the steps of:
a) connecting a drain hose at one end to a water heater drain valve, the hose comprising:
i) a drainage tube for drainage of water from the water heater;
ii) an agitator for agitating water within the drain hose, wherein the agitator is secured to the drainage tube;
iii) an exit valve for stopping the flow of water through the drainage tube, wherein the exit valve is located downstream of the agitator;
iv) a first connection at a proximal end of the drain hose for connecting the drain hose to a drain valve of the water heater; and
v) a second connection at a distal end of the drain hose for connecting the drain hose to suitable drainage location;
b) opening the drain valve on the water heater;
c) closing the exit valve on the drain hose;
d) activating the agitator on the drain hose to increase pressure of water in the drain hose, produce a reverse flow of water into the drain valve, and wherein the increased pressure provides a flow of water from the drain hose sufficient to reduce debris in the drain valve or the drain hose;
e) opening the exit valve on the drain hose to flush a mixture of debris and water from the hose; and
f) repeating steps c-e until a desired flow of water from the water heater during draining is achieved.

7. The method of claim 6, wherein the drainage tube of the drain hose is selected from the group consisting of piping or tubing.

8. The method of claim 6, wherein the agitator of the drain hose comprises a squeeze ball.

9. The method of claim 6, the drain hose further comprising a second drainage tube, wherein the agitator is secured between the two drainage tubes.

10. The method of claim 6, wherein the exit valve of the drain hose comprises a ball valve.

11. The method of claim 6, further comprising filling the drain hose with water before connecting the drain hose to the water heater drain valve.

12. A system for drainage of a water heater, the system comprising:
a water heater; and
a drain hose comprising:
a drainage tube for drainage of water from the water heater;
an agitator for agitating water within the drain hose, wherein the agitator is secured to the drainage tube;
an exit valve for stopping the flow of water through the drainage tube, wherein the exit valve is located downstream of the agitator;
a first connection at a proximal end of the drain hose for connecting the drain hose to a drain valve of the water heater; and
a second connection at a distal end of the drain hose for connecting the drain hose to suitable drainage location;
wherein the drain hose is connected to the water heater for drainage of water from the water heater and wherein activation of the agitator of the drain hose provides agitation sufficient to increase the pressure of the water in the drain hose, and wherein the increased pressure provides a flow of water from the drain hose sufficient to reduce debris in the drain valve or the drain hose.
